(19) United States
(12) Patent Application Publication
(10) Pub. No.: US 2014/0188433 A1
(43) Pub. Date: Jul. 3, 2014

(54) METHOD AND DIAGNOSTIC SYSTEM FOR SUPPORTING THE CONTROLLED FAULT DETECTION IN TECHNICAL SYSTEMS

(71) Applicants: Christian Erath, Stuttgart (DE); Mirko Wagner, Goeppingen (DE); Andreas Buse, Farmington Hills, MI (US); Martin Fritz, Buehl (DE)

(72) Inventors: Christian Erath, Stuttgart (DE); Mirko Wagner, Goeppingen (DE); Andreas Buse, Farmington Hills, MI (US); Martin Fritz, Buehl (DE)

(21) Appl. No.: 14/122,791

(22) PCT Filed: May 8, 2012
(86) PCT No.: PCT/EP2012/058468

§ 371 Date: Mar. 11, 2014

(30) Foreign Application Priority Data
May 31, 2011 (DE) 10 2011 076 766.5
Nov. 15, 2011 (DE) 10 2011 086 352.4

(51) Int. Cl. G01M 17/00; G01M 99/00

(52) U.S. Cl. CPC G01M 17/00; G01M 99/00
USPC 702/183

(57) ABSTRACT

A diagnostic system and a diagnostic method for a technical system are described with which, on the basis of the expert knowledge already necessary for the manual establishment of troubleshooting trees, the establishment of troubleshooting trees can be automated and the performance of guided troubleshooting can be assisted. Provided for this purpose are an acquisition module for systematic acquisition of all relevant status, observation, and/or measured data of the technical system, and a prioritization module for prioritizing all relevant tests, checks, or measurements, in order, in accordance with the weightings of the tests, checks, or measurements as a function of the status, observation, and/or measured data, to establish automatically a troubleshooting tree that can serve as a basis for guided troubleshooting.

### CROSS REFERENCE TO RELATED APPLICATION

The present application is the national stage entry of International Patent Application No. PCT/EP2012/058468, filed on May 8, 2012, which claims priority to Application No. DE 10 2011 086 352.4, filed in the Federal Republic of Germany on Nov. 15, 2011, and claims priority to Application No. DE 10 2011 076 766.5, filed in the Federal Republic of Germany on May 31, 2011.

### FIELD OF INVENTION

The present invention relates to a method and a diagnostic system for assisting guided troubleshooting in technical systems, in particular in motor vehicles.

### BACKGROUND INFORMATION

In technical systems having a plurality of components, in the event of failures or absence of functionality of the system it is often necessary to perform a stepwise sequence of tests, checks, and/or measurements in order to identify defective components or smallest replaceable units on the basis of the identified symptoms and/or reactions of the technical system. Because of the complexity of such systems, guided troubleshooting is often utilized, i.e., a problem-specific predefined sequence of separate tests and checks, in order to allow rapid, reliable, and unambiguous identification of faults with little test outlay.

German Application No. DE 103 07 365, for example, describes a diagnostic apparatus for a vehicle, in which apparatus status data of the vehicle are correlated in a calculation device with a fault diagnosis model, so that proposals for measurements to be carried out and/or measured data to be inputted for fault isolation can be identified.

Troubleshooting trees are one possible basis for guided troubleshooting. Troubleshooting trees represent stepwise troubleshooting strategies with which, based on simple decisions and observations, the set of all fault causes can be isolated to a subset of possible fault causes that is congruent with the observations. The quality of the guided troubleshooting operation is therefore decisively determined by the quality of the troubleshooting trees. The troubleshooting trees are usually established manually on the basis of the specialized knowledge of experts, requiring a large expenditure of time.

One possibility for carrying out guided troubleshooting is a so-called dynamic troubleshooting approach, where the available tests and checks are evaluated and prioritized only during the troubleshooting of the technical system. In dynamic troubleshooting an evaluation, as well as identification of possible defective components, is accomplished anew after each test that is carried out. Using a testing domain that, for example maps the associations between available tests and possible defective components to be checked, relevant tests can be identified automatically and can be subjected to evaluation using a program module.

German Application No. DE 10 2005 027 378 describes a diagnostic system that, by way of system queries regarding system states using a diagnostic program, generates a fault candidate set that encompasses prioritized fault candidates. Test steps are then proposed, the test results of which can serve for another evaluation of the fault candidate set.

### SUMMARY

The present invention is based on the idea of creating a diagnostic system and a diagnostic method for a technical system with which, on the basis of the expert knowledge already necessary for the manual establishment of troubleshooting trees, the establishment of troubleshooting trees can be automated and the performance of guided troubleshooting can be assisted. Provided for this purpose are an acquisition module for systematic acquisition of all relevant status, observation, and/or measured data of the technical system, and a prioritization module for prioritizing all relevant tests, checks, or measurements, in order, in accordance with the weightings of the tests, checks, or measurements as a function of the status, observation, and/or measured data, to establish automatically a troubleshooting tree that can serve as a basis for guided troubleshooting.

The relevant status, observation, and/or measured data can be made available in the acquisition module in the form of a structured ontology for the prioritization module, in which the ontology can then be correspondingly processed.

In contrast to known diagnostic systems and methods, only information from the domain of expert knowledge is necessary in the acquisition module, with no need to use physical models, Bayesian networks, or similar testing domains.

With the method and the diagnostic system in accordance with the present invention it is moreover advantageously possible to make gaps in knowledge visible, for example if, in the context of specific symptoms or feature manifestations, an unambiguous association with a defective component is not consistently possible with the possible tests to be carried out. The completeness of the guided troubleshooting operation can thereby be automatically and empirically checked. In particular, missing tests advantageously can be identified automatically. It is not necessary for this purpose for mathematical or physical modeling methods to be learned.

The present invention therefore, according to an exemplary embodiment, creates a method for assisting guided troubleshooting in a technical system, having the steps of acquiring a set of observations of the technical system; identifying on the basis of the set of observations a set of possible defective components of the technical system and a set of possible tests of the technical system that are to be carried out; identifying a set of possible component faults that is consistent with the set of observations; identifying a respective first absolute reduction in the number of elements of the set of possible defective components of the technical system which results from taking into consideration each of the possible feature manifestation combinations of each of the set of possible tests of the technical system that are to be carried out in the context of determination of the set of possible component faults; calculating on the basis of the identified first absolute reductions of each test a first prioritization of the set of possible tests to be carried out, by determining an average expected absolute reduction in the number of elements of the set of possible defective components of the technical system; identifying a respective second absolute reduction in the number of elements of the set of possible component faults of the technical system which results from taking into consideration each of the possible feature manifestation combinations of each of the set of possible tests of the technical system that are to be carried out; calculating on the basis of the identified reduction of each test a second prioritization of the set of possible tests to be carried out, by determining an average expected absolute reduction in the number of elements of the set of possible component faults of the technical system; and establishing on the basis of the first and the second prioritization a prioritized list of possible tests to be carried out.

According to a further exemplary embodiment, the present invention creates a diagnostic system for assisting guided troubleshooting in a technical system, having an acquisition device which is designed to acquire a set of observations on the technical system and to identify on the basis of the set of observations a set of possible defective components of the technical system and a set of possible tests of the technical system that are to be carried out; an identification device which is designed to identify a set of possible component faults that is consistent with the set of observations; a calculation device which is designed to identify a respective first absolute reduction in the number of elements of the set of possible defective components of the technical system which results from taking into consideration each of the possible feature manifestation combinations of each of the set of possible tests on the technical system that are to be carried out upon determination of the set of possible component faults, to calculate on the basis of the identified first absolute reductions of each test a first prioritization of the set of possible tests to be carried out by determining an average expected absolute reduction in the number of elements of the set of possible defective components of the technical system, to identify a respective second absolute reduction in the number of elements of the set of possible component faults of the technical system which results from taking into consideration each of the possible feature manifestation combinations of each of the set of possible tests of the technical system that are to be carried out, and to calculate on the basis of the identified second absolute reductions of each test a second prioritization of the set of possible tests to be carried out by determining an average expected absolute reduction in the number of elements of the set of possible component faults of the technical system; and an output device which is designed to establish and output on the basis of the first and the second prioritization a prioritized list of possible tests to be carried out.

In an advantageous exemplary embodiment, the method according to the present invention further encompasses the steps of identifying components, component faults, and tests relevant to the technical system; and associating the identified relevant component faults with symptoms and with identified relevant components.

It is thereby possible exclusively on the basis of expert knowledge, i.e., without needing to resort, e.g., to physical models, Bayesian networks, or other testing domains, to create a database of all component fault/symptom and component fault/feature manifestation correlations that is used as the basis for guided troubleshooting.

In an advantageous exemplary embodiment, the method encompasses the steps of selection by a user, from the set of possible defective components, of a component to be tested; identification of a respective third absolute reduction in the number of elements of the set of possible component faults of the selected component to be tested of the technical system, which is yielded by taking into consideration each of the possible feature manifestation combinations of each of the set of possible tests of the technical system that are to be carried out; calculation of a third prioritization of the set of possible tests to be carried out by determining an average expected absolute reduction in the number of elements of the set of possible component faults of the selected component to be tested of the technical system; and establishment on the basis of the third prioritization of a prioritized list of possible tests to be carried out for the selected component to be tested. The result is that instead of a general selection by a user of a test to be carried out, alternatively, when a defective component is suspected, the prioritization of the proposed test can be accomplished in terms of the benefit for ruling out or confirming the suspected component, so that a user can select tests in targeted fashion for a specific component.

The exemplary embodiments and refinements above can be combined in any way with one another to the extent that is advisable. Further possible exemplary embodiments, refinements, and implementations of the present invention also encompass combinations, not explicitly recited, of those features of the present invention which are described previously or below with reference to the exemplary embodiments.

Further features and advantages of exemplary embodiments of the present invention are described in the following with reference to the accompanying drawings.

### BRIEF DESCRIPTION OF THE DRAWINGS

FIG. 1 schematically depicts a dependency graph in accordance with an exemplary embodiment of the present invention.

FIG. 2 schematically depicts a method for assisting guided troubleshooting in a technical system, in accordance with a further exemplary embodiment of the present invention.

FIG. 3 schematically depicts a method for assisting guided troubleshooting in a technical system, in accordance with a further exemplary embodiment of the present invention.

FIG. 4 schematically depicts a method for assisting guided troubleshooting in a technical system, in accordance with a further exemplary embodiment of the present invention.

FIG. 5 schematically depicts a diagnostic system for assisting guided troubleshooting in a technical system, in accordance with a further exemplary embodiment of the present invention.

In the Figures, identical and functionally identical elements, features, and component are in each case labeled with the same reference characters unless otherwise stated. It is understood that for reasons of clarity and comprehension, components and elements in the drawings are not necessary reproduced at correct scale with respect to one another.

### DETAILED DESCRIPTION

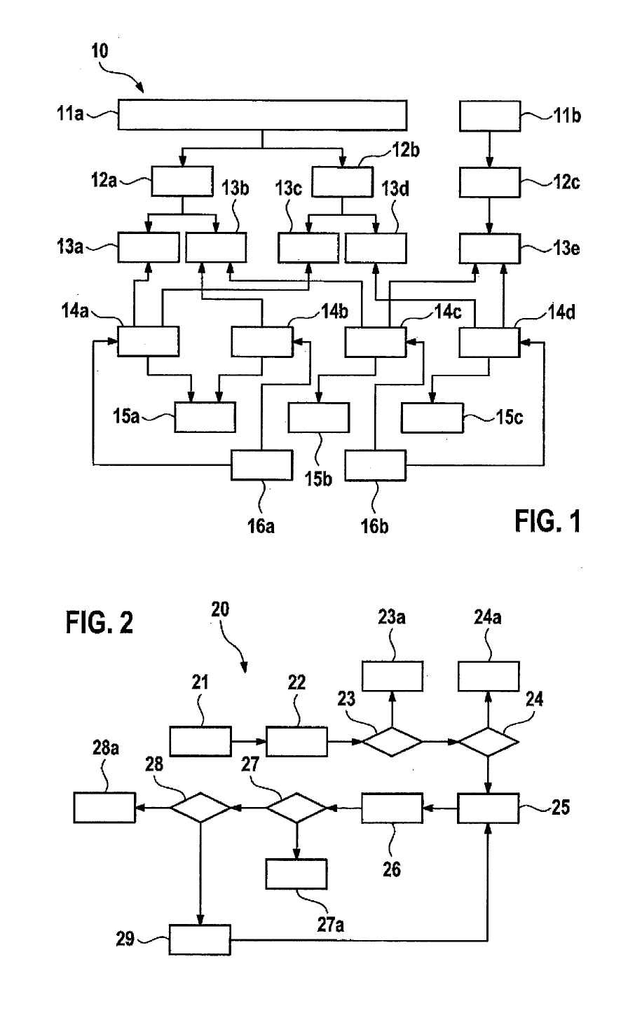

FIG. 1 schematically depicts a dependency graph 10. Dependency graph 10 schematically depicts the relationships among tests, their features and feature manifestations, components and component faults, and symptoms. The number of units depicted in FIG. 1 is only exemplary in each case, and any other number of relationships and occurrence frequencies is likewise possible for each unit.

Tests 11a and 11b, which possess features 12a and 12b, and 12c, respectively, are depicted. “Tests” for purposes of the present invention are all checks, measurements, or other observational interventions in a technical system that supply, as observed, tested, and/or measured data, information regarding features of the technical system. A concrete example of a test is, for example, an exhaust test on a vehicle. “Features” for purposes of the present invention are all information entities, the observation, measurement, or testing of which results in a different feature manifestation, which can occur for each test as feature manifestation combinations. A concrete feature in connection with the exhaust gas test on a vehicle mentioned as an example is, for example, the quantity of a gas constituent, for example carbon dioxide, contained in the exhaust of a vehicle. “Technical systems” for purposes of the present invention can encompass, for example, machines, production facilities, robots, systems, motor vehicles, or other complex technical assemblages of mutually functionally dependent technical components.

In FIG. 1, features 12a and 12b each have feature manifestations 13a and 13b as well as 13c and 13d, while feature 12c has only the feature manifestation 13e. The number of feature manifestations per feature is, however, unlimited in principle, and is defined by the nature of the feature. The dependency graph furthermore encompasses components 15a, 15b, and 15c of the technical system. “Components” for purposes of the present invention can be smallest replaceable units of a technical system, for example machine parts, vehicle parts, or the like.

Each of components 15a, 15b, and 15c can exhibit component faults 14a, 14b, 14c, and 14d. In the example of FIG. 1, component 15a can exhibit two different component faults 14a and 14b, while components 15b and 15c can each exhibit only one component fault 14c and 14d, respectively. “Component faults” for purposes of the present invention can represent all deviations from the standard state of the functionality of components, and are perceptible in particular by way of observations of the technical system. Component faults can be, for example, deviations in the output variables or measured variables of components.

Each of component faults 14a, 14b, 14c, and 14d has associated with it one or more feature manifestations 13a, 13b, 13c, 13d; in other words, when a set of feature manifestations 13a, 13b, 13c, 13d exists, the presence or absence of a component fault 14a, 14b, 14c and 14d can be inferred. For example, upon an occurrence of feature manifestations 13a and 13c of the two features 12a, 12b of test 11a, it can be inferred that component fault 14a of component 15a exists.

Dependency graph 10 furthermore encompasses symptoms 16a and 16b, which are a set of observable malfunctions of components of a technical system and in particular can be associated with one or more component faults. For example, symptom 16a is expressed as component faults 14a and 14b, whereas symptom 16b is expressed as component faults 14c and 14d. The symptoms can also encompass identifiers for the identification of malfunctions, so-called “displayed trouble codes” (DTCs), which can be acquired, stored, and retrieved, e.g., by control and diagnostic units in vehicles.

FIG. 2 schematically depicts a method 20 for assisting guided troubleshooting in a technical system. Method 20 encompasses, in a first step 21, acquisition of a set of observations on the technical system. The set of observations can encompass a set of the feature manifestations and symptoms known at the beginning of the method. Known feature manifestations and symptoms can, for example, characterize an initial state of the technical system. For example, before the method begins tests can already have been carried out on the technical system, and can have led to a set of initially known feature manifestations. In addition, observed malfunctions or deviations from normal states in the technical system can be known, and their occurrence can be associated with known symptoms.

In a second step 22, an identification occurs of a set of possible defective components and of possible tests that can be executed or carried out on the basis of the set of observations. Dependency relationships, for example such as those in the dependency graph in FIG. 1, can be utilized in this context in order to identify the set of possible defective components and possible tests that can be executed or are to be carried out. For example, the dependency relationships can be implemented by systematic analysis, experimental determination, or by the evaluation of statistically ascertained data that can be ascertained, for example, by evaluating the feedback from repair data. Known feature manifestations and symptoms can then be associated, by way of the dependency relationships, with those component faults which are consistent with the known feature manifestations and symptoms. By way of the consistent component faults, it is then possible to identify as possible defective components those components in which the consistent component faults can occur.

“Possible defective components” encompass all components of the technical system that can be responsible for a malfunction of the technical system which is consistent with the set of observations. The objective can subsequently be, by the selection or proposal of suitable further tests, to identify further observations or feature manifestations that can limit the set of possible defective components to a subset, in order ultimately to locate a defective component.

In the second step 22, prioritization parameters rank(tᵢ) and rank_{KKF}(tᵢ) can furthermore be identified; these allow a statement as to how helpful each test of the set NT of possible tests to be carried out can be in reducing the number of elements of the set MDK of possible defective components. For this, a prioritization can also be accomplished, inter alia, on the basis of the outlay for the particular test and the probability of occurrence of a component fault with reference to a symptom.

The prioritization parameter rank(tᵢ) can indicate, for example, an average expected reduction in the number of elements of the set MDK of possible defective components. An example will be given below of a method with which this reduction can be calculated, taking into consideration the probability of occurrence of a component fault with reference to a symptom.

For each test tᵢ of the set NT of possible tests to be carried out, the set KMKᵢ of all consistent feature manifestation combinations can be calculated. The elements of KMKᵢ are feature manifestation combinations, i.e. sets, of feature manifestations of test tᵢ that can occur respectively as a consequence of all elements of a set of possible component faults that can be responsible for the set of observations. For each consistent feature manifestation combination K_{(k,i)} of the set KMKᵢ of all consistent feature manifestations, the union set BMA_{(k,i)} of all observed feature manifestations having the consistent feature manifestation combination K_{(k,i)} can be determined. Based on the union set BMA_{(k,i)}, the new set KKF_{(k,i)} of all consistent component faults, and the new set MDK_{(k,i)} of possible defective components can be identified. In other words, the union set BMA_{(k,i)} generally encompasses more elements than the set of observations that was acquired in step 21, and thus decreases the number of elements of the set MDK_{(k,i)} of possible defective components. This decrease or first reduction r_{(k,i)} can be indicated as an absolute difference in the number of elements of the previous set MDK of possible defective components and of the new set MDK_{(k,i)} of possible defective components.

The identified first reduction r_{(k,i)} can then be weighted with the probabilities of occurrence for each consistent feature manifestation combination K_{(k,i)}. For this, the new set KKF_{(k,i)} of consistent component faults can be utilized, and for each combination of consistent component faults f_{(k,i)} a probability of occurrence p_{(k,i)} can be indicated, which can be summed over the set of all combinations of consistent component faults f_{(k,i)} to yield a total probability of occurrence pᵢ. The first absolute reduction r_{(k,i)} can then be multiplied by the total probability of occurrence pᵢ to indicate a weighted absolute reduction rg_{(k,i)}.

To identify the prioritization parameter rank(tᵢ), all weighted absolute reductions rg_{(k,i)} can be summed for each of the consistent feature manifestation combinations K_{(k,i)} of the set KMKᵢ of all consistent feature manifestations, and can be normalized to the number of elements of the set KMKᵢ of all consistent feature manifestations. It is furthermore optionally possible to weight the prioritization parameter rank(tᵢ) with an outlay parameter that can present a diagnosis outlay in terms of time and/or cost. Predetermined time values for special tests and measurement equipment, and optionally actual incurred costs for a test, can be utilized.

The prioritization parameter rank(tᵢ) thus provides for each test an indication that represents the benefit of the test in terms of a reduction in the number of elements of the set MDK of possible defective components.

The prioritization parameter rank_{KKF}(tᵢ) can likewise indicate an average expected reduction. In contrast to the prioritization parameter rank(tᵢ), the prioritization parameter rank_{KKF}(tᵢ) depends on the absolute expected reduction r_{KKF(k,i)} in the number of elements of the set KKF of consistent component faults. This decrease or second reduction r_{KKF(k,i)} can be displayed as an absolute difference in the number of elements of the previous set KKF of consistent component faults and of the new set KKF_{(k,i)} of consistent component faults.

The identified second reduction r_{KKF(k,i)} can then be weighted with the probabilities of occurrence for each consistent feature manifestation combination K_{(k,i)}. For this, the new set KKF_{(k,i)} of consistent component faults can be utilized, and for each combination of consistent component faults f_{(k,i)} a probability of occurrence P_{KKF(k,i)} can be indicated, which can be summed over the set of all combinations of consistent component faults f_{KKF(k,i)} to yield a total probability of occurrence p_{KKFi}. The absolute reduction r_{KKF(k,i)} can then be multiplied by the total probability of occurrence p_{KKFi} to indicate a weighted absolute reduction rg_{KKF(k,i)}.

To identify the prioritization parameter rank_{KKF}(tᵢ), all weighted absolute reductions rg_{KKF(k,i)} can be summed for each of the consistent feature manifestation combinations K_{(k,i)} of the set KMKᵢ of all consistent feature manifestations, and can be normalized to the number of elements of the set KMKᵢ of all consistent feature manifestations. It is furthermore optionally possible to weight the prioritization parameter rank_{KKF}(tᵢ) with the outlay parameter indicated above.

A third step 23 checks whether the number of elements of the set of possible defective components is greater than one. If only one possible defective component remains, the remaining component can be outputted in step 23a as the defective component. If the number of elements of the set of possible defective components is equal to zero, an alternative output in step 23a can be that the observations in the context of the model are not plausible.

If the number of elements of the set of possible defective components happens to be greater than one, a fourth step 24 checks whether the number of elements of the set of possible tests to be carried out is greater than one, i.e., whether any tests at all are still present which can be carried out and have not yet been carried out. If no further test is possible, this can be displayed to a user in step 24a. At the same time, in step 24a the previous list of all possible defective components can be outputted as a list of suspected components.

Based on the prioritization parameters rank(tᵢ) and rank_{KKF}(tᵢ), in step 25 a prioritized list NT of all possible tests to be carried out can then be identified and can be displayed to a user. The user can then select one of the proposed tests, carry it out, and add to the set of observations the results of the test that was carried out. As an alternative to selection by the user, the highest-priority test can be stipulated as a test to be carried out to the user, who must then carry out that test.

In a step 26, the set of observations obtained with the results of the test carried out in accordance with step 25 can then be added to. In addition, the set of possible tests that can be executed or are to be carried out can be updated. The prioritization parameters rank(tᵢ) and rank_{KKF}(tᵢ) are also recalculated on the basis of the new set of observations, for example with the aid of the method indicated above.

A check similar to steps 23 and 24 then occurs again in steps 27 and 28, the check being accomplished this time on the basis of the new set of possible defective components and the new set of possible tests to be carried out. Steps 27a and 28a correspond to steps 23a and 24a.

In a step 29, the display or output of the prioritized list of possible tests to be carried out can then be updated, provided the number of elements of the set of possible defective components is greater than one, and the number of elements of the set of possible tests to be carried out is greater than zero. The method can then be iterated from step 25 onward until one of the termination criteria checked in steps 27 and 28 is reached, or the user independently terminates the diagnostic method.

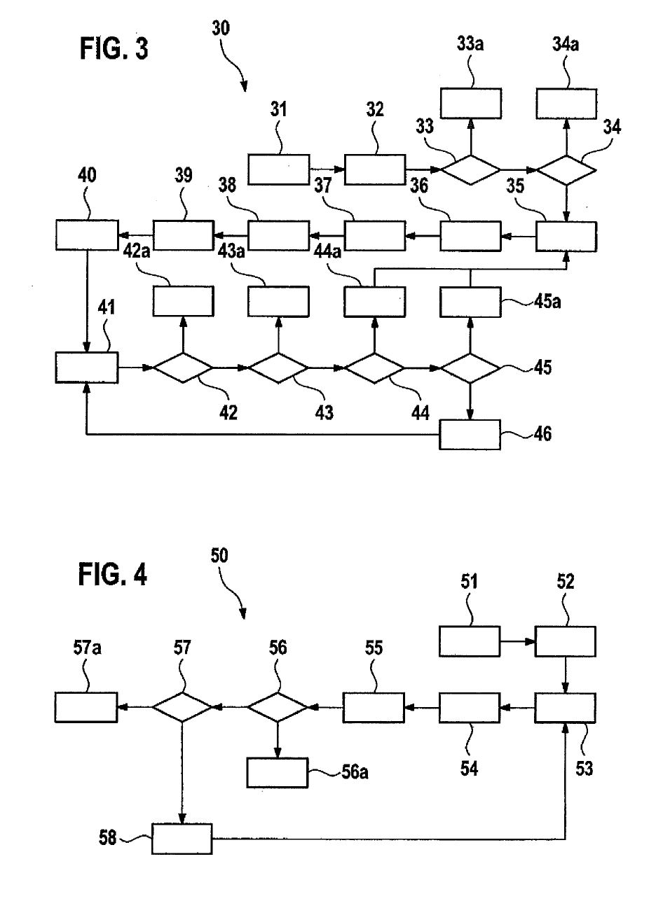

FIG. 3 is a schematic depiction of a method 30 for assisting guided troubleshooting in a technical system, for example in a vehicle to be diagnosed. Method 30 encompasses steps 31, 32, 33, 33a, 34, and 34a, which can correspond to steps 21, 22, 23, 23a, 24, and 24a of method 20 in FIG. 2. In a step 35, a user can then select a component K, from the set MDK of possible defective components, that he or she believes, for example, is possibly defective or on which he or she wishes to perform further investigations or tests. This can be advantageous, for example, when the vehicle to be diagnosed is already in a configuration state or diagnosis state that makes checking or testing of component K simple or obvious. For example, it can be advantageous to check a component of the exhaust system when the vehicle is at that time already on a lift. It can also be advantageous, if the user, based on similar symptoms with specific vehicle models, with specific weathering conditions, or with specific driving situations, has accumulated experience as to which of the components might with high probability be affected, to select that component K for testing.

In this case, in step 36 the set KKF_K of all consistent component faults is determined with reference to the component K selected in step 35. In step 37 the set NT_K of all possible tests to be carried out can then be identified on the basis of the set KKF_K of all consistent component faults. In step 38 a determination can be made of a further prioritization parameter rank_{K}(tᵢ) that, in contrast to the prioritization parameter rank_{KKF}(tᵢ), depends on the absolute expected reduction r_{KKF(k,i)} in the number of elements of the set KKF_K of consistent component faults of the selected component K.

The method for determining the prioritization parameter rank_{K}(tᵢ) can be carried out similarly to the method explained above for determining the prioritization parameter rank_{KKF}(tᵢ), consideration being given in each case only to those consistent component faults KKF_K which refer to the selected component K. The probabilities of occurrence p_{KKF(k,i)} p_{KKFi} are likewise adapted in terms of the selected component K.

In step 39 the remaining possible tests to be carried out can be identified on the basis of the selection of component K. On the basis of the prioritization parameter rank_{K}(tᵢ), the tests can be evaluated especially for the selected component K. For this, the prioritization parameter rank_{K}(tᵢ) can be utilized in step 40, for example for a new weighting of the prioritized list established with the aid of prioritization parameters rank_{KKF}(tᵢ) and rank(tᵢ). A user can then select one of the proposed tests on the basis of the reweighted prioritized list. Alternatively, the highest-priority test can be stipulated to the user for execution.

After a further test is carried out, in step 41 (similarly to step 26 in FIG. 2) the set of observations obtained with the results of the test carried out according to step 40 can be added to. Furthermore, the set of possible tests that can be executed or are to be carried out can be updated. The prioritization parameters rank(tᵢ) and rank_{KKF}(tᵢ) are also recalculated on the basis of the new set of observations, for example with the aid of the methods indicated above. Steps 42, 42a, 43, and 43a correspond to steps 27, 28a, 28, and 28a of method 20 in FIG. 2. Step 44 can furthermore check whether, as a result of the test additionally performed, the selected component K is still among the newly identified set of possible defective components. If this is not the case, step 44a can output the result that the selected component K is not defective. The user can then be directed on to step 35 for selection of another component K′. If the selected component is still present in the updated set of possible defective components, a step 45 can check whether further tests are possible for the selected component K. If this is not the case, the user can be directed on to step 35 for selection of another component K′.

If further tests turn out to exist for the selected component K, in step 46 a new test can be selected from the updated prioritized list of possible tests to be carried out for the selected component K, and carried out. Once the test is carried out the method returns to step 41, and can be iterated until one of the termination criteria checked in steps 42, 43, 44, and 45 is met, or the user him- or herself terminates the method.

FIG. 4 schematically depicts a method 50 for assisting guided troubleshooting in a technical system. Method 50 can serve, for example, to assist an author in establishing or optimizing a troubleshooting tree for guided troubleshooting in a technical system, for example a vehicle. In contrast to methods 20 and 30 in FIGS. 2 and 3 respectively, it is possible with method 50, for example, to describe that after a specific test A in which the feature manifestation Al has been identified, test B must always be carried out, with no possibility of the user changing the selection of the test. A stipulation of this kind can be made, for example, based on the author's expert knowledge.

In a first step 51, an acquisition occurs of a symptom to be processed, from a starting node in the troubleshooting tree to be established or optimized. In a second step 52, similarly to steps 22 and 32 in FIGS. 2 and 3, respectively, an identification is made of the set MDK of possible defective components and of the set NT of possible tests to be carried out on the basis of the set MDK of possible defective components and the set NT of possible tests to be carried out. In addition, in step 52 prioritization parameters rank(tᵢ) and rank_{KKF}(tᵢ) can be calculated in a manner similar to that explained above.

In step 53 the author can select, from the prioritized list of proposed tests to be carried out that was established in accordance with prioritization parameters rank(tᵢ) and rank_{KKF}(tᵢ), one of the tests in order to incorporate it into the troubleshooting tree. In step 54, for each possible combination of feature manifestations of the selected test the author can add a new branch or process an existing branch. After selection of one of the nodes in step 55, a check of termination criteria (similar to steps 23, 23a, 24, and 24a in FIG. 2) can occur in steps 56, 56a, 57, and 57a. Provided the number of elements of the set of possible defective components is greater than one, and the number of possible steps still to be carried out is greater than zero, in step 58 all the branches can be completed until the branches can be ended by termination criteria. Once the troubleshooting tree has been completed in terms of the selected test, the method can be iterated starting from step 53 until the entire troubleshooting tree has been established or optimized.

Using method 50, the author can achieve clarity as to which components are at present still identified as possible defective components, and which tests he or she can still execute given a particular group of symptoms. The author also obtains information as to which tests at the respective node or branch of the troubleshooting tree have the highest priority, i.e., the greatest benefit. Method 50 is therefore advantageously also suitable for checking existing troubleshooting trees to ensure they are complete and/or unambiguous.

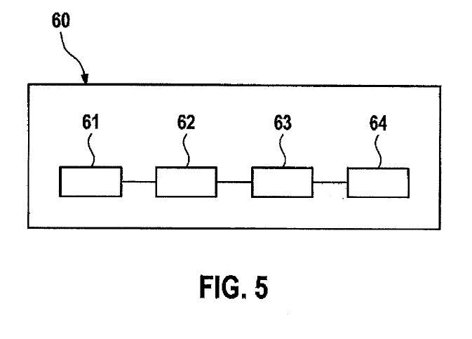

FIG. 5 schematically depicts a diagnostic system 60 for assisting guided troubleshooting in a technical system. The diagnostic system can be designed in particular to carry out one of the methods 20, 30, or 50 in FIGS. 2, 3, and 4.

Diagnostic system 60 encompasses an acquisition device 61 which is designed to acquire a set of observations of the technical system and to identify, on the basis of the set of observations, a set of possible defective components of the technical system and a set of possible tests to be carried out. Diagnostic system 60 furthermore encompasses an identification device 62 that is designed to identify a set of possible component faults that is consistent with the set of observations.

A calculation device 63 is set up to identify, on the basis of the set of possible component faults, an absolute reduction in the number of elements of the set of possible defective components of the technical system for each possible feature manifestation combination of each of the set of possible tests of the technical system that are to be carried out; to calculate, on the basis of the identified absolute reduction in each test, a first prioritization of the set of possible tests to be carried out by determining an average expected absolute reduction in the number of elements of the set of possible defective components of the technical system; to identify an absolute reduction in the number of elements of the set of possible component faults of the technical system for each possible feature manifestation combination of each of the set of possible tests to be carried out; and to calculate a second prioritization of the set of possible tests to be carried out, by determining an average expected absolute reduction in the number of elements of the set of possible component faults of the technical system.

Diagnostic system 60 further encompasses an output device 64 that is designed to establish and output, on the basis of the first and the second prioritization, a prioritized list of possible tests to be carried out. In addition, diagnostic system 60 can have an optional acquisition module (not shown) which is designed to acquire components, component faults, and tests relevant to the technical system, and to associate possible relevant component faults with symptoms and relevant components and possible feature manifestations of the relevant tests with possible symptoms and relevant components, and which is furthermore designed to make the relevant components, component faults, tests, and associations available to calculation device 63.

1-6. (canceled)

7. A method for assisting guided troubleshooting in a technical system, comprising:
acquiring a set of observations of the technical system;
identifying on the basis of the set of observations a set (MDK) of possible defective components of the technical system and a set (NT) of possible tests of the technical system that are to be carried out;
identifying a set (KKF) of possible component faults that is consistent with the set of observations;
identifying a respective first absolute reduction (r) in a number of elements of the set (MDK) of possible defective components of the technical system which results from taking into consideration each of possible feature manifestation combinations (KMK) of each of the set (NT) of possible tests of the technical system that are to be carried out in the context of determination of the set (KKF) of possible component faults;
calculating on the basis of the identified first absolute reductions (r) of each test a first prioritization (rank) of the set (NT) of possible tests to be carried out, by determining an average expected absolute reduction (rg) in the number of elements of the set (MDK) of possible defective components of the technical system;
identifying a respective second absolute reduction (r_{KKF}) in a number of elements of the set (KKF) of possible component faults of the technical system which results from taking into consideration each of the possible feature manifestation combinations (KMK) of each of the set (NT) of possible tests of the technical system that are to be carried out;
calculating on the basis of the identified second absolute reductions (r_{KKF}) of each test a second prioritization (rank_{KKF}) of the set of possible tests to be carried out, by determining an average expected absolute reduction (rg_{KKF}) in the number of elements of the set (KKF) of possible component faults of the technical system; and
establishing on the basis of the first and the second prioritization (rank, rank_{KKF}) a prioritized list of possible tests to be carried out.

8. The method according to claim 7, further comprising:
identifying components, component faults, and tests relevant to the technical system; and
associating the identified relevant component faults with symptoms and with identified relevant components.

9. The method according to claim 7, wherein the first and/or the second prioritization (rank, rank_{KKF}) are furthermore calculated on the basis of an outlay for carrying out each of the possible tests to be carried out.

10. The method according to claim 7, further comprising:
selecting by a user, from the set (MDK) of possible defective components, a component (K) to be tested;
identifying a respective third absolute reduction in the number of elements of the set of possible component faults of the selected component (K) to be tested of the technical system, for each possible feature manifestation combination (KMK_K) of each of the set of possible tests of the technical system that are to be carried out;
calculating a third prioritization (rank_{K}) of the set of possible tests to be carried out by determining an average expected absolute reduction in the number of elements of the set (KKF_K) of possible component faults of the selected component (K) to be tested of the technical system; and
establishing on the basis of the third prioritization (rank_{K}) a prioritized list of possible tests to be carried out for the selected component (K) to be tested.

11. A diagnostic system for assisting guided troubleshooting in a technical system, comprising:
an acquisition device which is adapted to acquire a set of observations on the technical system and to identify on the basis of the set of observations a set of possible defective components of the technical system and a set of possible tests of the technical system that are to be carried out;
an identification device which is adapted to identify a set of possible component faults that is consistent with the set of observations;
a calculation device which is adapted to identify a respective first absolute reduction in a number of elements of the set of possible defective components of the technical system which results from taking into consideration each of possible feature manifestation combinations of each of the set of possible tests of the technical system that are to be carried out upon determination of the set of possible component faults; to calculate on the basis of the identified first absolute reductions of each test a first prioritization of the set of possible tests to be carried out by determining an average expected absolute reduction in the number of elements of the set of possible defective components of the technical system; to identify a respective second absolute reduction in a number of elements of the set of possible component faults of the technical system which results from taking into consideration each of the possible feature manifestation combinations of each of the set of possible tests of the technical system that are to be carried out; and to calculate on the basis of the identified second absolute reductions of each test a second prioritization of the set of possible tests to be carried out by determining an average expected absolute reduction in the number of elements of the set of possible component faults of the technical system; and
an output device which is adapted to establish and output on the basis of the first and the second prioritization a prioritized list of possible tests to be carried out.

12. The diagnostic system according to claim 11, further comprising:
an acquisition module which is adapted to acquire components, component faults, and tests relevant to the technical system; to associate acquired relevant component faults with symptoms and acquired relevant components and possible feature manifestations of the relevant tests with possible symptoms and relevant components; and which is furthermore adapted to make the relevant components, component faults, tests, and associations available to the calculation device.
